(19) United States
(12) Patent Application Publication
(10) Pub. No.: US 2022/0094224 A1
(43) Pub. Date: Mar. 24, 2022

(54) STATOR FOR AN ELECTRICAL MACHINE, AND ELECTRICAL MACHINE

(71) Applicant: JHEECO E-DRIVE AG, Eschen (LI)

(72) Inventors: Pascal HUSER, Birmenstorf (CH); Martin STÖCK, Salez (CH)

(21) Appl. No.: 17/289,966

(22) PCT Filed: Oct. 30, 2019
(86) PCT No.: PCT/EP2019/079712

§ 371 Date: Apr. 29, 2021

(30) Foreign Application Priority Data
Oct. 31, 2018 (DE) 10 2018 218 731.2

(51) Int. Cl. H02K 3/24; H02K 3/50; H02K 9/19

(52) U.S. Cl. CPC H02K 3/24; H02K 9/19; H02K 3/50

(57) ABSTRACT

A stator for an electrical machine, comprising a stator laminated core and segment conductors accommodated in the stator laminated core, wherein at least a first segment conductor and a second segment conductor are provided, at their ends, with a respective contact-making region, the contact-making regions being connected to one another by means of a winding head, wherein the stator is provided with at least one cooling cap defining a duct for receiving cooling fluid therein, wherein the winding head protrudes into the duct, wherein the duct is provided with at least one fluid guide means, which is configured for directing the cooling fluid or at least part of the cooling fluid in the direction of the winding head, and also an electrical machine, comprising a rotor and a stator according to the present invention.

The present invention relates to a stator according to the preamble of claim 1 as well as to an electrical machine, in particular an electric motor, according to the preamble of claim 15.

An electric motor essentially comprises a stator and a rotor. For generating magnetic forces, windings are provided, which are energized in a suitable manner. The winding of the stator, which may comprise e.g. shaped strands and/or bar conductors, has so-called winding heads, which protrude at the axial ends of the stator laminated core.

Winding heads of electric motors become very hot. In order to prevent thermal failure, they are therefore often cooled. The cooling medium used is a dielectric cooling fluid (usually an oil). Oil cooling is normally implemented by means of a “cooling cap” defining an annular duct, which surrounds the winding head and in which a cooling fluid flows, as has become known for electrical machines, e.g. from DE102017107165A1.

This type of winding head cooling is also known for composite windings—i.e. segment conductors, which are inserted into stator slots and then connected to one another indirectly or directly. Directly means here e.g. that the bar conductors are bent towards one another and welded directly to one another; indirectly means the use of interconnection pieces, which bridge the distance between two bar conductors. Also the bar conductors and the interconnection pieces may be welded to one another. An example of interconnection pieces has become known from U.S. Pat. No. 4,321,497A. An example of bending towards one another has become known from US2014070639A1.

Segment conductors may, for example, be hairpins, i.e. solid conductor bars bent into a U-shape. It is also known to use shaped strands as segment conductors, i.e. pressed and possibly twisted wire strands. Reference may here, for example, be made to DE112015001994A5.

For effective cooling, it will be of advantage to cool those points where a high heat transfer coefficient can be accomplished. These are in particular those points where heat transfer between the cooling fluid and the electrical conductor is not prevented by any insulation (main insulation and in the case of a shaped strand also single wire insulation). At the same time, however, sufficient electrical insulation or a sufficiently long creepage distance must be ensured between the individual conductors, so as to prevent short circuits and flashovers.

For this reason, e.g. entire winding heads are completely potted into resin or the interconnection zones are individually covered with insulating resin or insulating caps. Both variants are disadvantageous because they impede the thermal transfer of heat. Alternatively, the distances between the contacting points are chosen so large that separate insulation is no longer necessary. A further possibility is the insertion of strips of insulating paper.

Analogously, if interconnection pieces are used, also they must be insulated from one another. To this end, interconnection pieces are e.g. coated with an insulating resin, have insulating paper inserted therein, or insulating spacers incorporated therein.

A disadvantage of the prior art is that the winding head in its entirety has applied thereto a constant flow of cooling fluid, since the transfer of heat is limited in a laminar cooling flow (formation of boundary layers).

This is the starting point for the present invention, which aims at suggesting an improved stator, in particular a stator whose winding heads can be cooled more effectively.

According to the present invention, this object is achieved by a stator having the characterizing features of claim 1.

Due to the fact that the duct for the cooling fluid (fluid duct) is provided with at least one fluid guide means, which is configured for directing the cooling fluid or at least part of the inflowing cooling fluid in the direction of the winding head, purposeful cooling can be carried out. In particular, those areas can be cooled in a purposeful manner which are presumably not insulated and where a transfer of heat between metal and cooling fluid will thus be possible. Insofar, local influencing of a cooling flow in the winding head, in particular in the winding head, preferably in the connection area of two conductors (segment conductor-segment conductor or segment conductor-interconnection piece), is suggested.

Further advantageous embodiments of the suggested invention result in particular from the features of the subclaims. The subject matters and features of the various claims can, as a matter of principle, be combined with one another in an arbitrary manner.

In this context, features and details described in connection with a method apply, of course, also in connection with the device according to the present invention and vice versa, so that with regard to the disclosure of the individual aspects of the present invention, reference is or can always be made reciprocally. In addition, a possibly described method according to the present invention can be carried out with the device according to the present invention.

According to an advantageous embodiment of the present invention, the segment conductor may be configured as a solid conductor or as a shaped strand.

According to another advantageous embodiment of the present invention, the contact-making region may be configured as a sleeve. This variant will be particularly suitable if the segment conductor is configured as a shaped strand, so as to provide a monolithic contact-making region for the individual wires of the shaped strand.

According to a further advantageous embodiment of the present invention, the winding head may comprise a weld and/or an interconnection piece.

According to another advantageous embodiment of the present invention, the winding head may be configured directly, i.e. the segment conductors may be welded to one another pairwise, or indirectly, i.e. the segment conductors may be connected to one another pairwise by means of an interconnection piece. Also the connection between the segment conductor and the interconnection piece is established preferably by welding. The segment conductors of composite windings must, as a matter of principle, be connected. As regards production technology, direct welding is less complicated than the use of interconnection pieces. However, interconnection pieces allow, in principle, to realize more complex winding patterns.

According to another advantageous embodiment of the present invention, the cooling cap and the duct, respectively, may be provided with an inlet and an outlet for cooling fluid, the outlet for the cooling fluid being arranged at a location remote from the inlet, preferably displaced by 180°. The inlet and the outlet can be used for introducing cooling fluid into the duct and for discharging it therefrom. A corresponding flow is created in the duct and in the intermediate ducts, respectively.

According to another advantageous embodiment of the present invention, the cooling cap may comprise a cover as well as two side walls. Furthermore, the cooling cap may be configured as a one-piece part or as a multi-piece part. A multi-piece structural design may e.g. be configured such that it comprises side walls and cover parts. The cooling cap is preferably made of a technically advantageous material. This material may, in particular, be an electrically insulating plastic.

According to another advantageous embodiment of the present invention, the fluid guide means may be configured as a nozzle, a vane, a recess, a rib, a raised or recessed accommodation of the segment conductor, in particular of the contact-making region, in an interconnection piece, and/or as a heat vane. The above-mentioned means represent preferred embodiments of a fluid guide means, the list being not exhaustive. Further embodiments are conceivable, as are basically any combinations of the above-mentioned means.

According to another advantageous embodiment of the present invention, the cooling cap may be provided with at least a double wall, comprising an inner wall and an outer wall, wherein an intermediate duct for the cooling fluid is formed between the inner wall and the outer wall, wherein at least one fluid guide means configured as a nozzle is arranged in the inner wall facing the winding head, the nozzle being adapted to direct the cooling fluid to and/or spray it onto an associated winding head. On the basis of this arrangement of the nozzles, the cooling fluid can be applied to and sprayed onto the winding heads very precisely, and the whole stator can thus be cooled very effectively. The nozzles are here advantageously directed at non-insulated parts of the winding head, preferably at the contacting points of the segment conductors. By means of a preferably perpendicular impact on the aforementioned parts or surfaces, an improved heat transfer can be achieved compared to a fluid just flowing past.

According to another advantageous embodiment of the present invention, at least one fluid guide means, configured as a vane, may be arranged in the duct, the vane being adapted to deflect at least part of the inflowing cooling fluid in the direction of the winding head. Also this embodiment of a fluid guide means allows an adequately precise incident flow onto a winding head. In addition, it can easily be realized in terms of production technology.

According to another advantageous embodiment of the present invention, the winding head may include an interconnection piece, wherein the contact-making region of the first segment conductor and the contact-making region of the second segment conductor are accommodated in the interconnection piece, wherein the fluid guide means is configured as a recess in the interconnection piece, the recess being arranged upstream of at least one contact-making region in the interconnection piece. This embodiment is essentially based on the fact that a targeted swirling of the cooling fluid can take place upstream of the segment conductor, in particular upstream of the contact-making region, which can contribute to efficient cooling. The swirling breaks up boundary layers and leads to higher heat transfer and better heat dissipation.

According to another advantageous embodiment of the present invention, the winding head may include an interconnection piece, wherein the fluid guide means is configured as a rib in the interconnection piece, the rib being configured to deflect at least part of the inflowing cooling fluid in the direction of the winding head, in particular in the direction of a contacting point. The rib essentially serves to deflect part of the cooling fluid flow in the direction of the contact-making region and/or to cause a turbulence effect in order to cool the contact-making region effectively.

In this connection, the rib or the ribs may preferably be oriented transversely or obliquely to the longitudinal direction of the interconnection piece and/or the rib or the ribs may be arranged on the upper side and/or on the lower side of the interconnection piece.

According to another advantageous embodiment of the present invention, the winding head may include an interconnection piece, wherein the contact-making region of the first segment conductor and the contact-making region of the second segment conductor are accommodated in the interconnection piece, the fluid guide means being formed by arranging the surface of at least one contact-making region above or below the interconnection piece surface. This design variant is particularly easy to implement, since the contact-making regions only have to be inserted or fixed slightly more or slightly less deeply in the openings provided in the interconnection piece. Nevertheless, turbulences useful for heat dissipation can also be generated in this way at a predetermined location.

A further object of the present invention is to be seen in suggesting an improved electrical machine, in particular an electric motor, in particular an electrical machine that can be cooled more effectively. According to the present invention, this object is achieved by an electrical machine having the characterizing features of claim 15. This allows the above outlined advantages of the stator according to the present invention to be used for the electric motor.

Further features and advantages of the present invention will become clear on the basis of the description of preferred embodiments which follows hereinafter and in which the accompanying drawings are referred to.

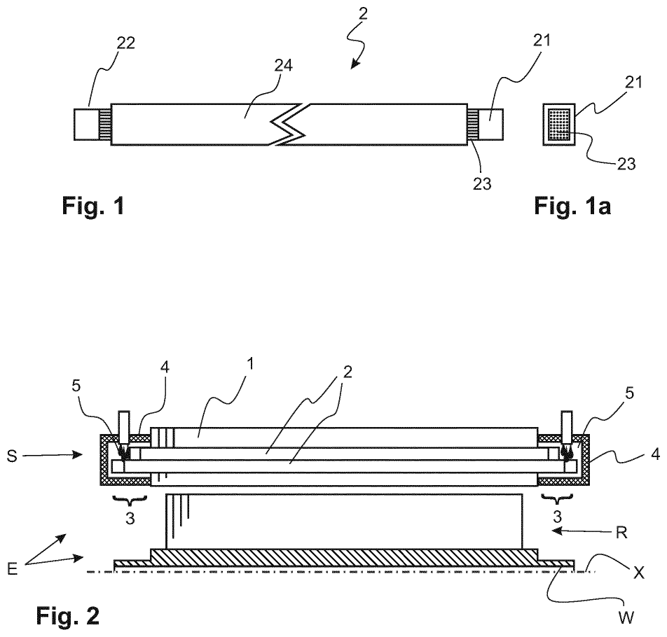

FIG. 1/1a show a segment conductor, in particular in the form of a shaped strand, of a stator according to the present invention in a top view and a sectional view;

FIG. 2 shows a cross-section through an electric motor (upper part) according to the present invention in a schematic sectional view;

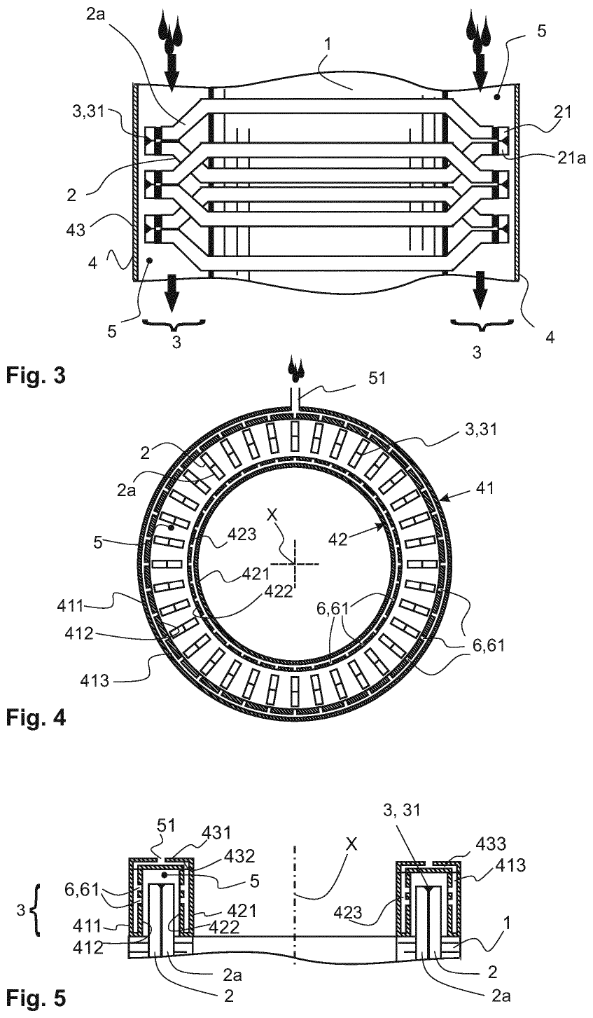

FIG. 3 shows a developed view of a stator laminated core with segment conductors connected via welded seams;

FIG. 4 shows a sectional top view of a cooling cap with nozzles for directly applying cooling medium to the segment conductor heads;

FIG. 5 shows a sectional side view of a winding head analogously to FIG. 4;

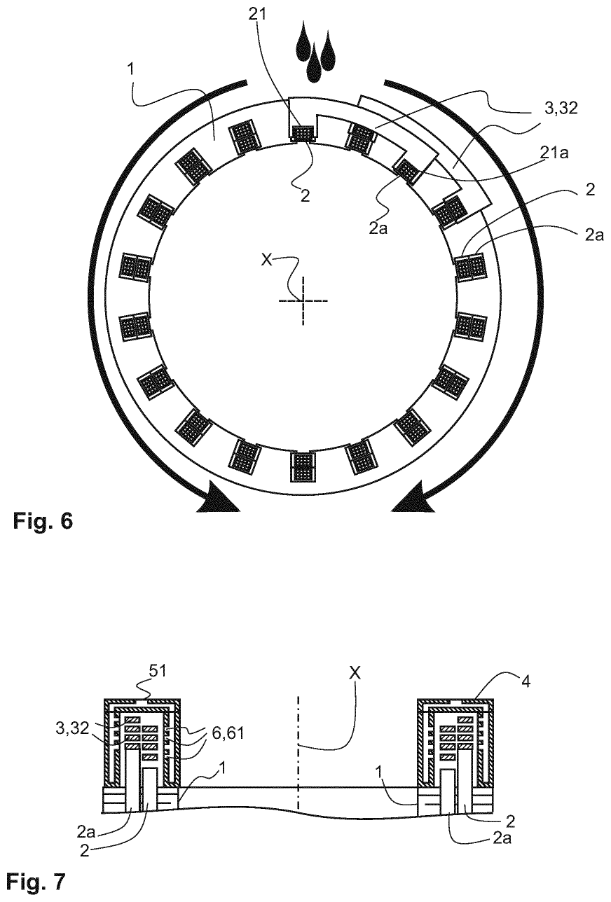

FIG. 6 shows a view of a stator with interconnection pieces for indirectly connecting two shaped strands;

FIG. 7 shows a view of interconnection pieces arranged in a multi-layer mode for implementing various winding patterns;

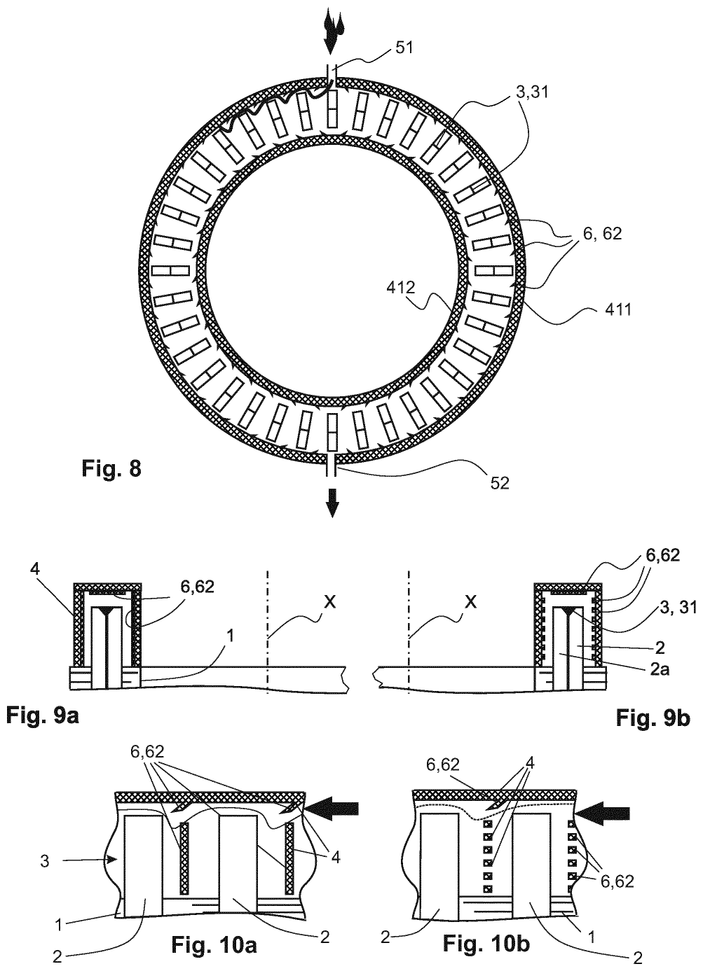

FIG. 8 shows a cooling cap with wall-side fluid guide means;

FIG. 9a,b show cover-/coverwall-side fluid guide means as well as continuous wall-side fluid guide means (FIG. 9a) and discontinuous fluid guide means (FIG. 9b);

FIG. 10a,b show cover-/coverwall-side fluid guide means as well as wall-side fluid guide means configured as continuous (FIG. 10a) and discontinuous (FIG. 10b) fluid guide means;

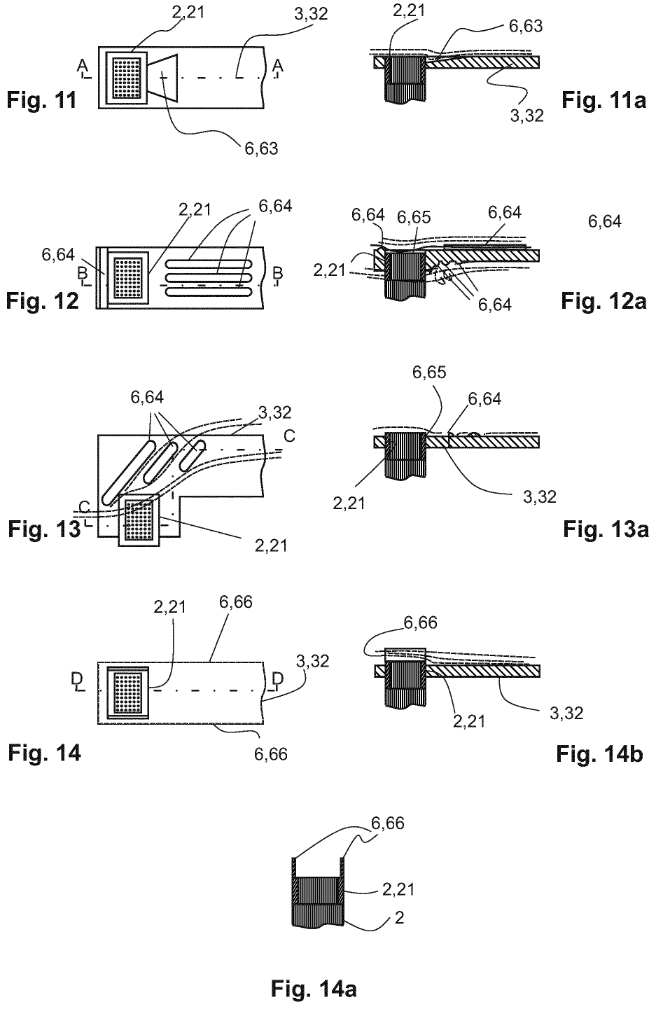

FIG. 11/11a show a recess in an interconnection piece in a top view (on the left) and a sectional view (on the right);

FIG. 12/12a show an interconnection piece with a transverse rib and longitudinal ribs on the upper side (on the left) and a segment conductor with an area recessed relative to the interconnection piece as well as transverse ribs on the lower side (on the right);

FIG. 13/13a show an interconnection piece with transverse ribs on one side (on the left), and with a segment conductor with a protrusion beyond the interconnection piece;

FIG. 14/14a show an interconnection piece with a shaped strand with an additional heat vane for increasing the surface area and exerting an influence on the flow.

To begin with, reference is made to FIG. 2.

An electric motor E according to the present invention substantially comprises a stator S according to the present invention and a rotor R. The electric motor E may be configured both as an internal rotor and as an external rotor. The rotor R has an axis of rotation or longitudinal axis X.

The stator S according to the present invention substantially comprises a hollow-cylindrical stator laminated core 1 in which longitudinally extending slots are arranged for accommodating therein segment conductors 2. Segment conductors 2 are accommodated in the slots and project beyond the stator laminated core 1 at their ends with their contact-making region 21, 22. The segment conductors 2 are connected to one another via the contact-making regions 21 and 22, respectively, according to a predetermined pattern. For example, a first segment conductor 2 is connected via its first contact-making region 21 to a second segment conductor 2a via the first contact-making region 21a of the latter. The connection can be established e.g. directly by means of welding 31 or also indirectly by means of interconnection pieces 32. The interconnection pieces are welded to the shaped strands. In the following, a winding head 3 will be referred to, which may optionally comprise an interconnection piece 32 and/or a weld 31.

The segment conductors 2 may, in particular, be solid bar conductors or also shaped strands. FIG. 1 shows exemplarily a segment conductor 2, which is configured as a shaped strand and which comprises two contact-making regions 21 and 22 at its ends and a wire bundle 23 arranged between the contact-making regions and provided with an insulation 24. In the present example, the contact-making regions 21, 22 are configured in the form of sleeves. The sleeves are applied to the head ends of the shaped strand in a hot crimping process. Other solutions are here conceivable as well.

The stator laminated core 1 has attached thereto, on each end, a cooling cap 4 defining a duct 5, in particular an annular duct, for a cooling fluid. The duct 5 and the cooling cap 4, respectively, comprise in particular two side walls 41, 42 and a cover 43. The resultant open side of the cooling cap 4 faces, accordingly, the stator laminated core 1 and is normally closed by the stator laminated core 1. The winding heads 3 projecting beyond the stator laminated core 1 protrude into the duct 5 or cooling cap 4 where a cooling fluid, usually an oil, can flow therearound and cool them in a suitable manner.

According to the present invention, the duct 5 and the cooling cap 4, respectively, are provided with fluid guide means 6, which are adapted to guide at least part of the fluid flow precisely onto the associated winding head 3 or winding heads 3 or to swirl it precisely in the area of the winding head 3.

Various embodiments of fluid guide means are conceivable. By way of example, a few embodiments will be illustrated making reference to the figures.

FIGS. 4 and 5 show a stator S according to the present invention, the fluid guide means 6 being configured e.g. as nozzles 61. For this purpose, the side walls 41, 42 of the cooling cap 4 are configured as double walls. Insofar, the first side wall 41 comprises an outer wall 411 and an inner wall 412. The second side wall 42 analogously comprises an outer wall 421 and an inner wall 422. An intermediate duct 413 is formed between the outer wall 411 and the inner wall 412. Likewise, an intermediate duct 423 is formed between the outer wall 421 and the inner wall 422.

Furthermore, also the cover 43 is provided with a double wall, in particular a cover inner wall 432 and a cover outer wall 431. Also in this case, an intermediate duct 433 is thus formed between the cover inner wall 432 and the cover outer wall 431.

Preferably, the intermediate ducts 413, 423 and 433 are in fluid communication with one another. The nozzles 61 are preferably arranged in the inner walls 412, 422 of the side walls 41, 42, so that the cooling fluid discharged from the nozzles 61 can be sprayed onto the winding heads 3 in a precisely oriented manner. Normally, an inlet 51 for the cooling fluid is arranged in the outer wall 411 of the first side wall 41. Also an outlet 52 for the cooling fluid is normally arranged in the outer wall 411 of the first side wall 41, but at a location remote from the inlet 51, preferably displaced by 180°.

With respect to the stator according to the present invention as shown in FIG. 7, embodiments according to FIGS. 4 and 5 can be referred to, the interconnection pieces 3 provided here being arranged in a multi-layer mode, e.g. for implementing various winding patterns. It can be seen that the arrangement of the nozzles 61 corresponds to the respective structural design and arrangement of the interconnection piece packs 32. The nozzles 61 are directed directly at the individual points of contact between the interconnection piece and the segment conductor 32, so that optimum cooling can be expected there.

FIG. 8 shows a further embodiment of the fluid guide means 6. Fluid guide means 6 in the form of vanes 62 facing in the direction of the duct 5 are attached to the side walls 41, 42. Starting from an inflow of the fluid at the inlet 51 and an outflow of the fluid at the remote outlet 52, which is in particular displaced by 180°, the vanes 62 are oriented such that the cooling fluid or at least parts of the cooling fluid is/are guided in the direction of the respective winding head 3, in particular the respective weld 31.

As illustrated by FIG. 9, the fluid guide means 6 in the form of wall-side vanes 62 may be of a continuous (FIG. 9a) or also discontinuous (FIG. 9b) nature. In addition, the fluid guide means 6 in the form of vanes 62 may also be attached to the cover 43 such that they face in the flow direction of the duct 5.

FIG. 10 show a stator S according to the present invention in a developed view, fluid guide means 6 in the form of vanes 62 being here attached to the inner side of the cover 43. The orientation of the vanes 62 with respect to an incident flow is such that a cooling fluid flowing in laterally is, at least partially, deflected in the direction of the winding heads 3, in particular the welds 31. Analogously to FIG. 9a,b, FIG. 10 illustrates that the vanes 62 attached to the wall may be configured as continuous vanes (FIG. 10a) or as discontinuous vanes (FIG. 10b).

The above-mentioned fluid guide means may be arranged on at least one side wall, preferably on both side walls, of the cooling cap.

FIGS. 11 to 14 show further embodiments of fluid guide means 6 of a stator according to the present invention.

As shown e.g. in FIG. 11, one or a plurality of, preferably all the interconnection pieces may be provided with a ramp-shaped recess 63 as fluid guide means 6. Preferably, the ramp is lowered in the direction of the contact-making region 21 accommodated in the interconnection piece 32, in particular in the direction of an accommodated sleeve as a contact-making region 21. As a result, an incident flow from the side will lead to a swirl or deflection upstream of the contact-making region 21.

Furthermore, as shown e.g. in FIG. 12, the interconnection piece 32 may have provided thereon at least one rib 64, in particular transversely and/or longitudinally, as fluid guide means 6. The ribs 64 may be arranged on the upper side as well as on the lower side of the interconnection piece 3 or, alternatively, on the upper side or on the lower side of the interconnection piece 3. In addition, the contact-making region 21, in particular the sleeve of a shaped strand, may, additionally or alternatively, be arranged in a slightly recessed manner in the interconnection piece 3, so that the surface of the contact-making region 21 or of the sleeve will be arranged slightly below the interconnection piece surface. In FIG. 12, the resultant indentation 65 can be seen.

FIG. 13 shows an example for a fluid guide means comprising oblique ribs 64 with respect to the longitudinal axis of the interconnection piece 3. Furthermore, the contact-making region 21, in particular the sleeve of a shaped strand, may, additionally or alternatively, be arranged in a slightly raised mode in the interconnection piece 3, so that the surface of the contact-making region 21, in particular of the sleeve, will be arranged slightly above the interconnection piece surface. In FIG. 13, the resultant elevation 65 can be seen.

A further embodiment of a stator with fluid guide means is shown in FIG. 14. The fluid guide means comprises here heat vanes 66, which are attached to the segment conductor 2 or contact-making region 21 and in particular project perpendicularly with respect to the interconnection piece surface.

Additionally or alternatively, the contact-making region 41, in particular the sleeve of a shaped strand, may be arranged in a slightly raised mode in the interconnection piece 3, so that the surface of the contact-making region 21 will be arranged slightly above the interconnection piece surface.

In summary, there are numerous possible combinations of the respective structural designs of the fluid guide means 6, which may be configured e.g. as a nozzle 61, a vane 62, a recess 63, a rib 64 and/or a raised or recessed accommodation of the contact-making region 21 or 22 in the interconnection piece 3. In particular the nozzle 61 and the vanes 62 may preferably be arranged in or on the side wall 41, 42 or the cover wall 43 of the cooling cap 4. The recess 63 or the rib 64 is preferably arranged in or on the interconnection piece 3. As a matter of principle, the embodiments and/or combinations of the fluid guide means 6 are here not exhaustively listed, so that further forms and/or combinations are conceivable.

The intended flow path is represented in each case by the serpentine lines in the figures.

It is preferably assumed that the winding heads are, partly or fully, not insulated, but especially that the electrical connection points of the segment conductors are not insulated, and that a flow of fluid is directed onto respective non-insulated areas by the fluid guide means. Depending on the respective structural design, interconnection pieces may be insulated or non-insulated outside the contacting points. Nevertheless, an improved heat dissipation may be obtained even for insulated winding heads by means of the measures suggested according to the present invention. In principle, the fluid guide means may also be used for directing a flow of fluid onto other, preferably non-insulated areas of the stator, so as to improve the overall thermal balance of the stator.

The fluid guide means 6 can be integrated into already existing parts in a cost-efficient and simple manner; no separate components will then be necessary.

The following reference numerals are used in the figures:
R rotor
S stator
W shaft
E electrical machine/electric motor
X axis of rotation/longitudinal axis
1 stator laminated core
2 segment conductor
2a segment conductor
3 winding head
4 cooling cap
5 duct
6 fluid guide means
21 contact-making region
21a contact-making region
22 contact-making region
23 wire bundle
24 insulation
31 weld
32 interconnection piece
41 first side wall
42 second side wall
43 cover
51 inlet
52 outlet
61 nozzle
62 vane
63 recess/ramp
64 rib
65 elevation/indentation
66 heat vanes
411 outer wall
412 inner wall
413 intermediate duct
421 outer wall
422 inner wall
423 intermediate duct
431 cover outer wall
432 cover inner wall
433 intermediate duct

1. A stator for an electrical machine, comprising:
a stator laminated core and segment conductors accommodated in the stator laminated core, wherein
at least a first segment conductor and a second segment conductor are provided, at their ends, with a respective contact-making region, the contact-making regions being connected to one another by means of a winding head, wherein
the stator is provided with at least one cooling cap defining a duct for receiving cooling fluid therein, wherein
the winding head protrudes into the duct,
wherein the duct is provided with at least one fluid guide means, which is configured for directing the cooling fluid or at least part of the cooling fluid in the direction of the winding head.

2. The stator according to claim 1, wherein the segment conductor is configured as a solid conductor or as a shaped strand.

3. The stator according to claim 1, wherein the contact-making region is configured as a sleeve.

4. The stator according to claim 1, wherein the winding head comprises a weld or an interconnection piece.

5. The stator according to claim 1, wherein the cooling cap and the duct, respectively, are provided with an inlet and an outlet for cooling fluid, the outlet for the cooling fluid being arranged at a location remote from the inlet.

6. The stator according to claim 1, wherein the cooling cap comprises a cover as well as two side walls.

7. The stator according to claim 1, wherein the fluid guide means is configured as a nozzle, a vane, a recess, a rib, a raised or recessed accommodation of the segment conductor, in particular of the contact-making region, in an interconnection piece, and/or as a heat vane.

8. The stator according to claim 1, wherein the cooling cap is provided with at least a double wall comprising an outer wall and an inner wall, wherein an intermediate duct for the cooling fluid is formed between the inner wall and the outer wall, wherein at least one fluid guide means configured as a nozzle is arranged in the inner wall facing the winding head, the nozzle being adapted to direct the cooling fluid to or spray it onto an associated winding head.

9. The stator according to claim 1, wherein at least one fluid guide means, configured as a vane, is arranged in the duct, the vane being adapted to deflect at least part of the inflowing cooling fluid in the direction of the winding head.

10. The stator according to claim 1, wherein the winding head includes an interconnection piece, wherein the contact-making region of the first segment conductor and the contact-making region of the second segment conductor are accommodated in the interconnection piece, wherein the fluid guide means is configured as a recess in the interconnection piece, the recess being arranged upstream of at least one contact-making region in the interconnection piece.

11. The stator according to claim 1, wherein the winding head includes an interconnection piece, wherein the fluid guide means is configured as a rib on the interconnection piece, the rib being configured to deflect at least part of the inflowing cooling fluid in the direction of the winding head.

12. The stator according to claim 1, wherein the rib or the ribs are oriented transversely or obliquely to the longitudinal direction of the interconnection piece.

13. The stator according to claim 1, wherein the rib or the ribs are arranged on the upper side and/or on the lower side of the interconnection piece.

14. The stator according to claim 1, wherein the winding head includes an interconnection piece, wherein the contact-making region of the first segment conductor and the contact-making region of the second segment conductor are accommodated in the interconnection piece, the fluid guide means being formed by arranging the surface of at least one contact-making region above or below the interconnection piece surface.

15. An electrical machine, comprising a rotor and a stator according to claim 1.

16. The stator according to claim 5, wherein the outlet for the cooling fluid is arranged at a location remote from the inlet, displaced by 180°.

17. The stator according to claim 16, wherein the contact-making region is configured as a sleeve.

18. The stator according to claim 17, wherein the winding head comprises a weld or an interconnection piece.

19. The stator according to claim 18, wherein the cooling cap and the duct, respectively, are provided with an inlet and an outlet for cooling fluid, the outlet for the cooling fluid being arranged at a location remote from the inlet, displaced by 180°.

20. The stator according to claim 19, wherein the cooling cap comprises a cover as well as two side walls.
